(19) United States
(12) Patent Application Publication
(10) Pub. No.: US 2006/0129347 A1
(43) Pub. Date: Jun. 15, 2006

(54) Generic transducer interface

(75) Inventors: Rajit Gadh, Los Angeles, CA (US); Shivanand B. Prabhu, Los Angeles, CA (US); Xiaoyong Su, Los Angeles, CA (US); Harish Ramamurthy, Los Angeles, CA (US)

Correspondence Address: VIERRA MAGEN MARCUS & DENIRO LLP, 575 MARKET STREET SUITE 2500, SAN FRANCISCO, CA, 94105, US

(73) Assignee: The Regents of the University of Californica, Oakland, CA (US)

(21) Appl. No.: 11/294,102

(22) Filed: Dec. 5, 2005

Related U.S. Application Data
(60) Provisional application No. 60/635,031, filed on Dec. 10, 2004.

(51) Int. Cl. G01M 19/00

(52) U.S. Cl. 702/127; 702/122

(57) ABSTRACT

A generic transducer interface includes a hardware connector, such as a pin connector, with connection points for electrically connecting to a transducer, a control, a non-volatile memory for storing firmware used to configure the control, and a wired/wireless communication interface. The firmware indicates pre-assigned functions of the connection points, as well as providing: (a) data processing services, which perform operations on data elements from the transducers to obtain results which are reported to an external host, (b) data reporting and reception services, which include a data reporting protocol for reporting data from the transducers to the host, and a data receiving protocol for receiving data from the host, and (c) transducer management services, which allow retrieval and reconfiguration of transducer-specific properties. Transducer-specific configuration data received from the external host configures the control with the information it needs to act as an interface for a particular transducer.

### CROSS-REFERENCE TO RELATED APPLICATIONS

This application claims the benefit of U.S. provisional patent application No. 60/635,031, filed Dec. 10, 2004, entitled “Generic Transducer Interface”, and incorporated herein by reference.

### BACKGROUND

A transducer refers generally to a device, such as a sensor or actuator, that converts one type of energy to another. Transducers types include thermal, photo, magneto, pressure, humidity, proximity, optical, vibration or biometric transducers, for instance. A transducer exchanges information with the external world using electrical signals which can include digital data, analog data, timer/interrupt signals or serial data, for instance. A transducer can be characterized by its information exchange method (usage of signals) and the information communicated.

Various efforts have been made to develop a “one-size-fits-all” solution for a generic transducer interface. For example, the IEEE 1451 group has proposed different standards to describe a transducer, the interaction of a transducer with a communication interface, the communication interface and the formation of intelligent systems in which the interface is used. The IEEE 1451 proposal uses a serial interface for transducer communication with a “smart” transducer, which is required to convert its data to a serial format for communication. Further, each transducer is required to store a transducer electronic data sheet (TEDS), and communicate this information as needed.

However, in order to accommodate most of the existing transducers, the protocol has introduced a substantial amount of overhead, which may result in degradation of the application performance or make it cost prohibitive to implement. For example, a TEDS description of a simple single channel pressure sensor requires 565 bytes of data. The complete solution thus puts too much burden on the transducer implementation. Furthermore, the transducer must be custom designed in accordance with the standard, thereby resulting in additional cost and complexity. Due to these drawbacks, such efforts have experienced limited success.

A solution is needed for providing a low cost, flexible generic transducer interface which is compatible with existing transducers.

### SUMMARY

The technology herein, roughly described, provides a generic transducer interface platform which can be configured for use with one or more transducers.

The solution provides a lightweight approach to characterizing transducers and enabling intelligent communication with an external host for collecting data or controlling the transducers. Intelligence can be distributed across the system elements, thereby reducing the implementation load on any particular element.

In particular, a generic interface may be provided which includes a hardware connector, such as a pin connector, with connection points for electrically connecting to one or more transducers, a control, a non-volatile memory for storing firmware used to configure the control, and a communication interface. The communication interface can communicate via a wired or wireless path. The components may be mounted on a circuit board, for instance. In particular, the firmware may indicate pre-assigned functions of the connection points. For example, specified connection points can be pre-assigned for receiving analog or digital data, receiving or transmitting serial data, receiving an interrupt, providing a general purpose input/output, receiving a timer signal, and receiving bus data or a bus clock signal. The firmware can also provide: (a) data processing services, which perform operations on data elements from the transducers to obtain results which are reported to an external host, (b) data reporting and reception services, which include a data reporting protocol for reporting data from the transducers to the host, and a data receiving protocol for receiving data from the host, and (c) transducer management services, which allow retrieval and reconfiguration of transducer-specific properties.

The interface can receive transducer-specific configuration data from the external host via the communication interface. The configuration data provides the control with the information it needs to act as an interface for one or more particular transducers. For example, the configuration data can identify which of the connection points are to be used with a particular transducer. The configuration data can also describe parameters to be used for reading analog or digital data from the particular transducer, such as a voltage range or a sampling rate, a number of timers and respective time periods for reading data, and so forth. The configuration data can include data elements, a data processing service configuration, a data reporting configuration and a data reception configuration.

Advantageously, the interface can be configured at the time of manufacturer or in the field for use with a particular transducer. Moreover, once configured, the interface can be reconfigured for use with additional or different transducers. Thus, a single interface provides significant flexibility.

### BRIEF DESCRIPTION OF THE DRAWINGS

FIG. 1 depicts a schematic of a configurable transducer interface.

FIG. 2 depicts a process for configuring an interface.

FIG. 3 depicts a data structure for performing a first computation at an interface.

FIG. 4 depicts a data structure for performing a second computation at an interface.

FIG. 5 depicts a process for performing computations at an interface.

### DETAILED DESCRIPTION

A generic transducer interface should have the ability to interface with raw analog/digital/interrupt-based transducers and provide a unified control interface. Such a unified control interface can enhance the flexibility of implementing systems where varied sensors need to be interfaced to satisfy application requirements. For example, an automobile includes a number of sub-systems such as an anti-lock brake system, a suspension system, an emissions system, and so forth. Monitoring the operational status of an automobile thus involves data retrieval, fusion and processing from a high-density of varied transducers. A generic transducer interface can alleviate the problem of heterogeneity and facilitate the porting of efficient applications over such systems. Details of such a generic transducer interface are provided below.

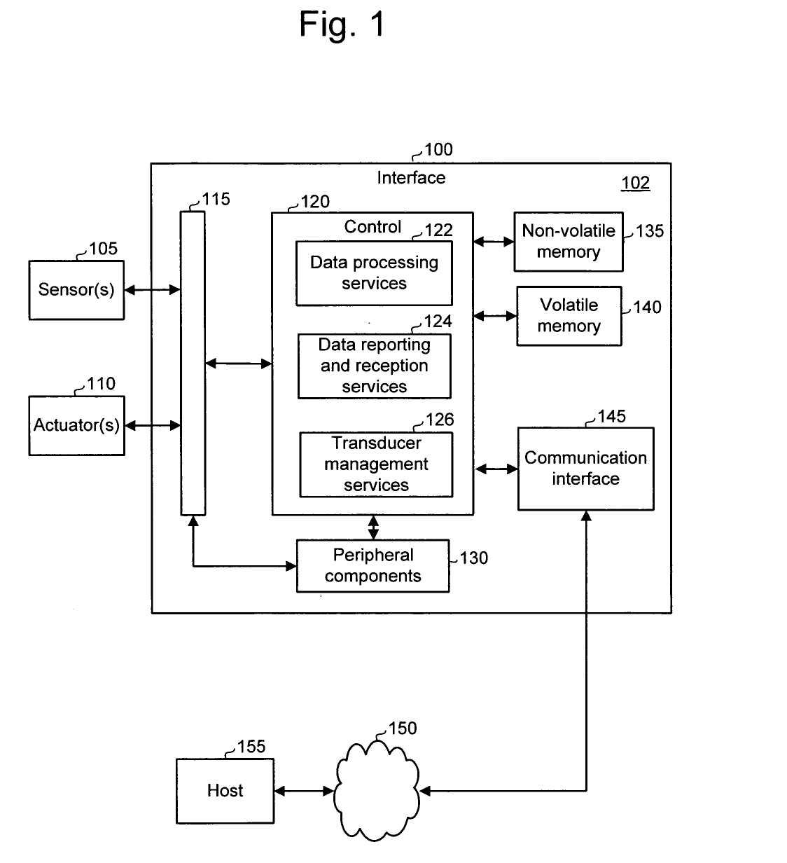

FIG. 1 depicts a schematic of a configurable transducer interface. The transducer interface is a microcontroller based implementation which includes a generic interface to physically connect to one or more transducers. In particular, the interface 100 may include a hardware connector 115, a control 120, e.g., including one or more microprocessors, a non-volatile memory 135, a volatile memory 140 and a communication interface 145. The hardware connector 115 may be a pin connector, for instance, which is electrically connectible to one or more transducers. In one possible implementation, a standard 51-pin connector can be used. One or more sensors 105 and actuators 110 are provided as example transducers. The non-volatile memory 135 stores firmware which identifies pre-assigned functions of the pins/sockets of the hardware connector 115. The pins are electrically coupled to the control 120 and other components on a circuit board 102, for instance. The firmware can also provide: (a) data processing services 122, which perform operations on data elements from the transducers to obtain results which are reported to the external host 155, (b) data reporting and reception services 124, which include a data reporting protocol for reporting data from the transducers to the host, and a data receiving protocol for receiving data from the host, and (c) a transducer management services 126, which allow retrieval and reconfiguration of transducer-specific properties. The services may be provided in respective modules, for instance.

Generally, the hardware connector 115, control 120, non-volatile memory 135, volatile memory 140 and communication interface 145 can be embedded in the circuit board 102 at the time of manufacturer. Also, at the time of manufacture, or subsequently, in the field, one or more desired transducers can be connected to the hardware connector 115. The volatile memory 140 serves as a working memory for holding the firmware from the non-volatile memory, once the control is booted, as well as other data that the control may use, including transducer-specific configuration data received via the communication interface 145.

For example, the external host computer 155 may send transducer-specific configuration data to the interface 100 via a network 150. The transducer-specific configuration data can include data elements, a data processing service configuration, a data reporting configuration and a data reception configuration. The host computer 155 may use any type of programming technique to configure the control 120 with the transducer-specific information, which allows the control 120 to read signals from, and/or provide commands to, one or more particular transducers. The host 155 may include a user interface, for instance, to allow a user to perform the configuration, or the configuration may be performed automatically. Note also that the interface may communicate with more than one host. For example, a first host may provide configuration data to the interface, while the interface reports transducer data to a second host. Additionally, more than one host may provide configuration data to the interface, and the interface can report transducer data to more than one host. Further, the configuring of the interface and the reporting of data may be separated in time.

The communication interface 145 may use a wired or wireless path to communicate with the host 155. Wireless communications using Bluetooth, Wi-Fi, Zigbee or GPRS, for instance, have shown promise for many applications. Bluetooth is a short range radio technology aimed at simplifying communications among Internet devices and between devices and the Internet, as well as simplifying data synchronization between Internet devices and other computers. Wi-Fi, or wireless fidelity, is refers to any type of IEEE 802.11 network, including 802.11b, 802.11a or dual-band. ZigBee is a low data rate, two-way standard pioneered by Philips Semiconductors for home automation and data networks. GPRS, or General Packet Radio Service, is a standard for wireless communications which runs at speeds up to 115 kilobits per second.

The interface 100 may also include peripheral components 130, such as analog-to-digital converters (ADCs), digital-to-analog converters (DACs), Universal Asynchronous Receiver-Transmitters (UARTs), Universal Synchronous-Asynchronous Receiver/Transmitters (USARTs), timers, clocks, data buses and the like. The peripheral components 130 may be embedded in the circuit board 102.

The memories 135 and 140 may be considered to be computer-readable media having computer readable code embodied thereon for programming at least one processor, e.g., in the control 120, to perform a method for configuring a transducer interface.

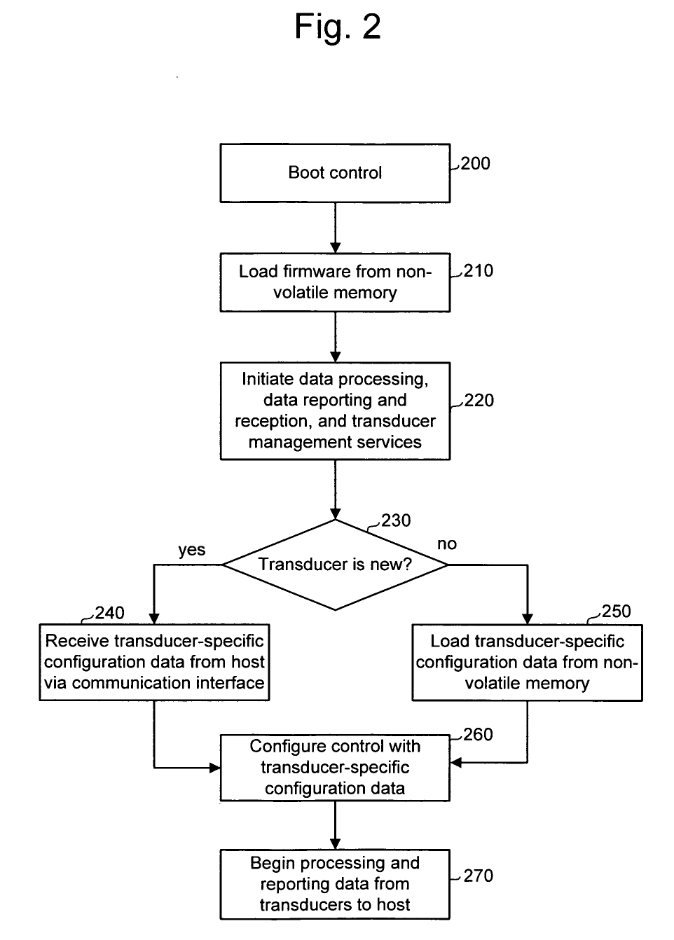

FIG. 2 depicts a process for configuring an interface. The configuration process can begin with the control being booted (step 200), which includes loading firmware from the non-volatile memory to the volatile memory (step 210). The firmware can include pin assignment information as well as information for providing the baseline data processing, data reporting and reception, and transducer management services, which are not specific to a given transducer. The baseline services are subsequently customized for use with particular transducers when the transducer-specific configuration data is received from the host. Thus, at step 220, the baseline data processing, data reporting and reception and transducer management services can be initiated. At step 230, if the transducer is new, that is, it has been installed in the interface, but the interface has not been configured for use with the transducer, the interface receives transducer-specific configuration data from the host via the communication interface (step 240). This configuration data includes data that is specific to one or more particular new transducers which are to be used with the interface. On the other hand, if the transducer is not new (step 230), the interface has previously received and stored the configuration data in non-volatile memory. In this case, the transducer-specific configuration data is loaded from the non-volatile memory (step 250). At step 260, the control is configured with the configuration data by storing the configuration data in appropriate data structures in the volatile memory. The interface is now ready to process data from the one or more particular transducers and report it to the external host (step 270).

Table 1 provides examples of the general types of transducer-specific information that an interface can be configured with to interface with one or more particular transducers. For example, an interface may receive analog data from a transducer, in which case the interface can be configured with a voltage range and a sampling rate. To receive digital data from a transducer, the interface can be configured with a resolution and a measurement unit. To use timers to determine time periods for sampling signals from the transducers, for instance, the interface can be configured with the number of timers to use and the associated time periods. For example, a first timer may be used to sample a first signal from a transducer after a first time period, while a second timer is used to sample a second signal from the transducer after a second time period. Furthermore, the interface may be configured with information relating to interrupts. An interrupt, which can be generated by software or hardware, refers to a signal that informs the control that an event has occurred. When the control receives an interrupt signal, it can temporarily stop its current programming task to service the interrupt by taking a specified action. In this regard, an interface can be configured with the number of interrupts which are needed to interface with a transducer, and the relative priority of the interrupts. For receiving serial data from, or sending serial data to, the transducer, the interface can be configured with the baud rate of the data, and an indication as to whether handshaking is used. Regarding I²C or I2C communication, this refers to an inter-IC bus which is used to connect multiple integrated circuits (ICs) or chips. If such a bus is used to interface with a transducer, the interface can be configured with the clock speed.

For example, raw sensors typically use a combination of the types of information mentioned in Table 1 to convey and receive information, and thus, logically, can be characterized by a data acquisition method-hardware-properties template. For example, consider a single channel pressure sensor, which can be characterized as “1-channel analog, voltage range” at the hardware communication interface. The sampling rate, warm-up time and so forth can be selected at the reconfigurable firmware level.

TABLE 1

| | Sample Hardware | Sample Firmware |
|---|---|---|
| Information: | Properties: | Properties: |
| Analog Data | Voltage Range | Sampling Rate |
| Digital Data | Resolution | Measurement Unit |
| Timers | Number of Timers | Time Period |
| Interrupts | Number of Interrupts | Priority |
| Serial Data | Handshake? | Baud Rate |
| I²C Communication | — | Clock Speed |

As mentioned, the interface is provided with information from a host which characterizes one or more transducers for which the interface is to be configured. A transducer can be initially classified by its pin usage at the hardware connector. Additionally, other specific information or configuration data relating to a particular transducer can be characterized in the reconfigurable transducer firmware based on information provided by the host. One possible implementation of a pinout, or pin assignment, is provided in Table 2. Table 2 indicates pre-assigned pin functions. Generally, the interface can store the pin assignment in firmware in the non-volatile memory so that the assignment is available when the control boots up. The pin assignment indicates respective functions which are pre-assigned to each of the pins or other connection points of the hardware connector. The pins are electrically coupled to the control and other components on the interface, for instance. The interface can subsequently receive configuration data from the host which indicates which pins are to be used with one or more particular transducers. For example, only a subset of the pins may be used in many cases. For example, in the case of a linear position sensor, which is an analog sensor, pins 1 (Vcc—Voltage Supply), 2 (GND—Voltage Return) and 4 (ADC0—Analog Channel) are used. In another example, a brushless DC (BLDC) motor may use pins 1 (Vcc—Voltage Supply), 2 (GND—Voltage Return), 3 (Vdd—Tunable Supply), 11 (DAC0—Digital to Analog Converter for Speed Control), and 14 (DIG0—Digital Pin for Enabling/Disabling the Motor) and 15 (DIG1—Digital Pin for Setting the Direction). This configuration data is specific to the one or more transducers as well as a particular arrangement of the one or more transducers in the hardware connector.

The pre-assigned functions of the pins can be designed to accommodate a variety of different types of transducers, including transducers that provide analog or digital data, transducers that require timers to be used for reading data at specified times, transducers that require bus data, transducers that require interrupts, and transducers that send or receive serial data. Additionally, multiple transducers can be accommodated at the same time. Note that more than one connector may be used as well in an interface in association with one or more controls. The pin assignment provided is an example only as various other options are possible. Once the pin assignment is decided on at the design phase of the interface, the interface can be constructed accordingly with the appropriate components and connections. Further, the host may maintain a library of different transducers and their pin assignments. In this case, the user need only identify the transducer, and the host can provide the corresponding pin assignment information to the interface.

In Table 2, ADC denotes an analog-to-digital converter, DAC denotes a digital-to-analog converter, GPIO denotes a general purpose input/output, I2C denotes an inter-IC bus, UART denotes a Universal Asynchronous Receiver-Transmitter, USART denotes a Universal Synchronous-Asynchronous Receiver/Transmitter, Rx denotes receive, Tx denotes transmit and VAC denotes alternating current voltage. Pins 14-32 are named DIG0-DIG18, respectively.

TABLE 2

| Pin: | Name: | Description: |
|---|---|---|
| 1 | Vcc | Supply Voltage |
| 2 | GND | Ground |
| 3 | Vdd | Tunable Supply |
| 4 | ADC0 | ADC Channel 0 |
| 5 | ADC1 | ADC Channel 1 |
| 6 | ADC2 | ADC Channel 2 |
| 7 | ADC3 | ADC Channel 3 |
| 8 | ADC4 | ADC Channel 4 |
| 9 | ADC5 | ADC Channel 5 |
| 10 | ADC6 | ADC Channel 6 |
| 11 | DAC0 | DAC Channel 0 |
| 12 | DAC1 | DAC Channel 1 |
| 13 | DAC2 | DAC Channel 2 |
| 14-32 | DIG0-DIG18 | GPIO |
| 33 | I2C_Data | I2C bus data |
| 34 | I2C_Clk | I2C bus clock |
| 35 | T0 | Timer 0 |
| 36 | T1 | Timer 1 |
| 37 | T2 | Timer 2 |
| 38 | INT0 | Interrupt 0 |
| 39 | INT1 | Interrupt 1 |
| 40 | INT2 | Interrupt 2 |
| 41 | INT3 | Interrupt 3 |
| 42 | UART_R | Serial Rx |
| 43 | UART_T | Serial Tx |
| 44 | UART_CLK | Serial Clock |
| 45 | USART_R | Serial Rx |
| 46 | USART_T | Serial Tx |
| 47 | USART_CLK | Serial Clock |
| 48 | AC˜ | 110 VAC |
| 49 | AC˜ | 110 VAC |
| 50 | Vdd− | Negative Tunable Supply |
| 51 | Vss | Negative Supply |

The firmware run by the control is a reconfigurable generic transducer firmware for implementing the functionality required to gather and process data from one or more transducers and transmit it to an application at the host. The interface maintains the transducer specific properties and helps port data processing modules/routines at the transducer level. Moreover, the firmware provides the data processing, data reporting and receiving, and transducer management services, as discussed in further detail below.

Data Processing Services: The transducer may transmit information using various types of electrical signals. Furthermore, different peripheral signals, or data elements, can be provided from hardware peripherals on the interface, such as USART data, analog data and the like. For example, in a pressure sensor, the data element which represents pressure is collected at the sampling rate defined. Additionally, software peripherals can provide constants, preset values and the like. Accordingly, processing, including sequencing, computations and the like, may be required before the data from the transducer can be transmitted to the host. These functions can be performed by the data processing services. The data elements can be collected and fused, e.g., combined, as defined by a data configuration, a sample layout of which is provided in items (a)-(d) below.

(a) Configuration length—the length of the configuration data in bytes.

(b) Data elements—includes a list of data elements and an indication as to how many data elements are provided. For example, for an interface which is connected to three pressure sensors, a list of data elements to be reported will include the respective pressure readings and, optionally, identifiers of the pressure sensors. Data elements can be referenced by a pointer to the hardware peripherals (e.g., ADC) or software peripherals (e.g., constants, software generated or preset values). The data elements, such as pointers or constants, are defined by the transducer management services. The number of data elements present in the configuration will be less than or equal to the total number of data elements defined by the transducer management services.

(c) Computations—includes a list of computations and an indication as to how many computations are provided. Each computation defines processing between two or more data elements, or operations, for instance, (a) (bit 0 AND bit 1) OR (NOT bit 2), (b) (ADC0+ADC1−ADC2) and (c) (ADC2−0x0F). Each computation has a unique identifier attached to it, and the result of the computation is stored in the volatile memory referenced by a computation identifier (id). Moreover, the logic operations and analog computations can be performed over groups of data elements, as indicated by the examples above. To make the firmware lightweight, limited data fusion services can be supported. Table 3 provides an example layout of the operations which may be supported.

TABLE 3

| Operation (id): | Operation: | Description: |
|---|---|---|
| 0 | Not defined | Not defined |
| 1 | Logic operations | OR |
| 2 | | AND |
| 3 | | NOT |
| 4 | Analog computations | Addition - with constants and |
| | | sampled values |
| 5 | | Subtraction - with constants and |
| | | sampled values |
| 6 | Inequalities | Greater |
| 7 | | Lesser |
| 8 | | Equal |
| 9 | Interrupts | Enabling/disabling/altering |
| | | transducer properties |
| 10 | Memory | Support for storing data in |
| | | memory |
| 11 | Assignments | Support for dynamically |
| | | modifying the parameters of any |
| | | data element |

(d) Results—the list of data elements to be finally reported by the interface to the host.

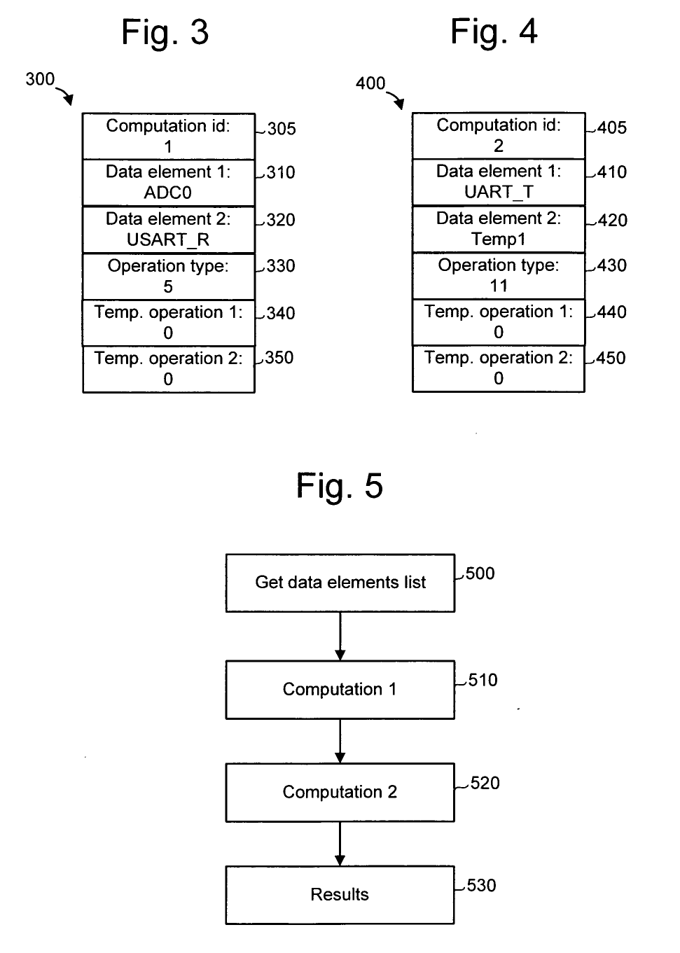

An example of computations performed by the data processing services is provided in connection with FIGS. 3 and 4. FIG. 3 depicts a data structure for performing a first computation. Consider an application in which an analog signal from a transducer is provided to an ADC on the interface. The output of the ADC is to be sampled and subtracted from data which is output from one serial USART to provide a result which is sent to another serial UART. A data structure 300 includes a computation id of “1” in field 305, indicating that this is the first computation. Fields 310 and 320 provide data elements which are involved in an initial operation. In particular, a first data element in field 310 is ADC0, indicating ADC channel 0 (from Table 2), and a second data element in field 320 is USART_R, indicating a serial receive channel. Field 330 identifies the operation which is to be performed on the data elements in fields 310 and 320. In particular, an operation type of “5” in field 330 indicates subtraction (from Table 3). First and second temporary (temp.) operations in fields 340 and 350, respectively, have a zero value. The data structure is therefore processed by the control to apply a subtraction operation to the data values ADC0 and USART_R, i.e., to obtain the value ADC0−USART_R.

Note that, for all computations, except inequalities, the fields titled “temp. operation” are not used. The end result will be stored in the temporary storage referenced by computation id. For inequalities, “temp. operation 1” will be executed if the result of “operation type” is true and “temp. operation 2” will be executed if the result of “operation type” is false. The “temp. operation” field cannot be one of the inequalities, e.g., operations 6-8 in Table 3.

After the first computation is performed, a second computation is performed as indicated by the data structure of FIG. 4. Data structure 400 indicates a computation id of “2” in field 405, indicating that this is the second computation. A first data element involved in the computation is provided in field 410 as UART_T, indicating a serial transmit channel. A second data element in field 420 is Temp1, indicating a temporary value from computation “1”. Generally, the temporary result from computation “n” is denoted by TempN. An operation type of “11” in field 430 indicates assignment (from Table 3). First and second temporary operations in fields 440 and 450, respectively, have a zero value because the computation does not involve an inequality, as explained above. The data structure is processed by the control to assign the value of Temp1 to UART_T, i.e., UART_T=Temp1. UART_T is the value that is reported to the host.

FIG. 5 depicts a process for performing computations at an interface. The computation of FIGS. 3 and 4 can be summarized as follows. At step 500, the control gets the data elements list, which includes, in the above example, ADC0, USART_R and UART_T. At step 510, computation 1 is performed using the data structure 300 of FIG. 3. In particular, the data structure is parsed, ADC0 and USART_R are retrieved, and Temp1=ADC0−USART_R is computed. At step 520, computation 2 is performed using the data structure 400 of FIG. 4. In particular, the data structure is parsed, and UART_T=Temp1 is computed. Finally, at step 530, the results are obtained.

The control can use the volatile memory as a temporary storage space or working memory for performing the computations. This is especially useful when group computations are performed. To keep the requirements thin, e.g., to minimize overhead processing requirements, such as memory size and processor speed, the size of volatile memory can be restricted, e.g., to 64 bytes. Thus, a maximum of 16 operations, with 4 bytes per operation, can be performed on data before communication, in one approach. Although this restricts the ability to implement complex algorithms, the functionality should be sufficient for most application scenarios. The declaration of fusion operations can be defined using the configuration functionality provided by the transducer management services.

Data Reporting and Reception Services: These services package the data from the one or more transducers for final communication to the host. The data reporting service, in a data mode, can use a defined transmittal/reporting pattern or protocol to specify how data elements, which can include computed data elements from the data processing services, will be transmitted to the host. The data elements to be communicated can be obtained as a result of a series of logical, analog, or other fusion computations. For example, consider a pH sensor which transmits an analog acidic value and a digital index number. The pH value is measured and compared with the base threshold (pH=7 for water) to calculate the acidic value. The transmittal pattern could include the index-number followed by the acidic value. Similarly, the data reception services, in a command mode, can process data, including the transducer-specific configuration data, which is received from the host in a pre-defined pattern and forward it to the respective service module for action. For example, reconfiguration parameters can be provided to the transducer management services. Both transmittal and reception patterns can be configured through the transducer management services.

The data reporting protocol can be stored in the non-volatile memory of the interface. A sample memory layout is presented below:

(a) Data reporting protocol length—the length of the data reporting protocol configuration in bytes.

(b) Data elements—includes a list of data elements and an indication of how many data elements are in the list. Data elements can be referenced by a pointer to the hardware peripherals (e.g., ADC) or software peripherals (constants, software generated, computed values or preset values). The data elements, such as pointers or constants, are defined by the transducer management services. The number of data elements present in the configuration should be less than or equal to the total number of data elements defined by the transducer management services.

(c) Data elements tags—each data element can be enclosed within a tag and transmitted. For example, a data element representing a temperature value from a transducer can be enclosed within the ‘T’ tag, e.g., <T>23.2</T>, using an XML schema. The data elements tag property can be set by the transducer management services.

(d) Data elements order—lists the order in which the data elements will be transmitted to the host.

(e) Update period—provides the average period between two transmissions.

Similarly, a data reception/receiving protocol can be provided which defines the format of received data from the host. In the example provided, the data reception protocol is similar to that of the data reporting protocol, with minor modifications, as follows:

(a) Data reception protocol length—the length of the data reception protocol configuration in bytes.

(b) Data elements—includes a list of data elements and an indication of how many data elements are in the list. Data can be either referenced by a pointer to the hardware peripherals (e.g., DAC) or software peripherals (e.g., constants, or preset values). The data elements, such as pointers or constants, are defined by the transducer management services. The number of data elements present in the configuration should be less than or equal to the total number of data elements defined by the transducer management services.

(c) Data elements tags—each data element can be enclosed within a tag and transmitted. For example, a temperature threshold can be enclosed within the ‘TH’ tag, e.g., <TH>23.2</TH>, using an XML schema. The data elements tag property can be set by the transducer management services.

(d) Data elements order—lists the order in which the data elements will be received.

(e) Event Generation—flag to indicate whether an event needs to be generated. The corresponding event service routine is also indicated.

Transducer Management Services: These services enable the retrieval and reconfiguration of transducer-specific properties, e.g., configuration data, from one or more external hosts. For example, this can include information regarding hardware peripherals, e.g., the hardware and software properties, such as the number of UARTs used, the baud rate and the number of stop-bits. An example listing of peripherals and their properties or characteristics which may be provided by the external host is provided in Table 4. Essentially, this information includes transducer-specific configuration data that is used to configure the data processing service, data reporting service, data receiving service and transducer management service for use with one or more particular transducers.

TABLE 4

| Peripheral: | Hardware Properties: | Software Properties: |
|---|---|---|
| Analog channel: | Bit resolution | Sampling rate |
| | Voltage Range - lower and upper | Timing - setup, aperture read and write |
| | limit | |
| | Run - enable/disable | Connection - receive, post and suppress |
| | | events |
| | I/O direction | Calibration parameters |
| Digital channel: | Number of bits | Clocking rate |
| | Voltage Range - lower and upper | Timing - rise and fall |
| | limit | |
| | Run - enable/disable | Connection - receive, post and suppress |
| | | events |
| | I/O direction | |
| UART: | Handshake protocol - none, | |
| | Xon/Xoff, RTS/CTS | |
| | Number of UARTs | Connection - receive, post and suppress |
| | | events |
| | Run - enable/disable | |
| I²C: | Run - enable/disable | Clock rate |
| | | Connection - receive, post and suppress |
| | | events |
| Timers: | Number of timers | Timing - time period |
| | Counters, event generators | Connection - receive, post and suppress |
| | | events |
| | Run - enabled: continuous, one-time, | |
| | event-based, disabled | |
| Interrupts: | Number of interrupts | Priority |
| | Run - enable/disable | Connection - receive, post and suppress |
| | | events |
| Self-identification: | | Unique identifier |
| | | Input/output response time |
| | | Error protection scheme |
| | | Operating temperature/moisture |
| | | Connection - receive, post and suppress |
| | | events |
| Event Handler: | | Event connection and sequencer |
| Data processor | | Configuration for data processor service |
| Configuration: | | |
| Data Formatter | | Configuration for data formatter service |
| Configuration: | | |

In Table 4, Xon and Xoff, respectively, are signals used in UART communication between the communicating elements, e.g., the transducer interface and the transducer, or the transducer interface and the host, to start or stop sending data. RTS denotes a “request to send” hardware pin. CTS denotes a “clear to send” hardware pin.

Each peripheral can receive/post and suppress events. An action is associated with each kind of event. For example, consider an analog channel sending data over a UART. The analog-converted-data is posted as an event, and this event is received by the UART. The description of these “connecting events” can be defined dynamically through the event handler. The event handler registers event connection/priorities and sequences them.

As mentioned, a transducer can be defined by its data elements, data processing service configuration, data reporting configuration and data reception configuration. The interface for the transducer is configured by updating the aforementioned parameters using the transducer management service.

Practical Considerations

The current generation of automation systems, control and monitoring systems, security systems, and the like, all have the capability to share information over a network, and are being increasingly employed to aid real-time decision support. The inter-device communication in such systems can be leveraged to maximize the efficiency and convenience in a variety of situations. Intelligent transducer based controls have gained significant attention due to their flexibility, compactness and ease of use in remote unattended locations and conditions. These transducer modules can be designed to combine sensing, provide in-situ computation, and contact-less communication into a single, compact device, providing ease in deployment, operation and maintenance. Already, large-scale sensor networks having different capabilities are being used to monitor real-time application needs.

Different types of transducers (e.g., thermal, photo, magneto, pressure, humidity, proximity, optical, vibration, biometric and others) having different capabilities, interfaces and supporting different protocols are used for different applications. The generic transducer interface discussed herein provides a single comprehensive architecture to support the diverse control automation needs of a variety of industrial applications. The data collection/actuation units are made intelligent by equipping them with smart microcontroller based hardware interfaces as discussed herein. Utilizing the plug-n-play modularity of the system architecture, appropriate sensor interfaces can be chosen according to the application requirements. Further, once the interface is chosen, the application interface could be used to implement the specifics such as description, placement, interaction of sensors and actuators, and so forth. For example, the interaction could be a closed loop control of a motor, where the sensor is an encoder, and the actuator is a motor.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A configurable transducer interface, comprising:
a hardware connector for electrically connecting to a transducer, the hardware connector having a plurality of connection points;
a control configured to identify pre-assigned functions of the connection points; and
a communication interface for receiving transducer-specific configuration data from an external host for configuring the control for use with the transducer.

2. The configurable transducer interface of claim 1, wherein:
the transducer-specific configuration data identifies a subset of the connections points to be used by the transducer.

3. The configurable transducer interface of claim 1, wherein:
the transducer-specific configuration data identifies respective subsets of the connections points to be used by respective different transducers which are connectable to the hardware connector.

4. The configurable transducer interface of claim 1, further comprising:
a non-volatile memory storing firmware for configuring the control to identify the pre-assigned respective functions.

5. The configurable transducer interface of claim 4, further comprising:
a circuit board on which the hardware connector, control, communication interface and non-volatile memory are provided.

6. The configurable transducer interface of claim 1, wherein:
the communication interface communicates with the external host via a wired or wireless path.

7. The configurable transducer interface of claim 1, wherein:
the control is configured to provide a data processing service for processing data from the transducer.

8. The configurable transducer interface of claim 1, wherein:
the control is configured to provide a data reporting service for reporting data from the transducer via the communication interface.

9. The configurable transducer interface of claim 1, wherein:
the control is configured to provide a data receiving service for receiving data via the communication interface.

10. The configurable transducer interface of claim 1, wherein:
the control is configured to provide a transducer management service.

11. The configurable transducer interface of claim 1, further comprising:
a non-volatile memory storing firmware for configuring the control to process data from the transducer, report data from the transducer via the communication interface, and receive the transducer-specific configuration data via the communication interface.

12. The configurable transducer interface of claim 11, wherein:
the transducer-specific configuration data identifies at least one of: (a) a number of timers to be used for reading data from the transducer and (b) a time period for reading data from the transducer.

13. The configurable transducer interface of claim 1, wherein:
the transducer-specific configuration data received identifies at least one parameter to be used for reading analog and/or digital data from the transducer.

14. The configurable transducer interface of claim 13, wherein:
the at least one parameter comprises at least one of a voltage range and a sampling rate.

15. The configurable transducer interface of claim 13, wherein:
the at least one parameter comprises at least one of a resolution, when analog data is read from the transducer, and a measurement unit.

16. The configurable transducer interface of claim 13, wherein:
the at least one parameter comprises at least one of a number of interrupts and a priority of interrupts, when digital data is read from the transducer.

17. The configurable transducer interface of claim 13, wherein:
the at least one parameter comprises a clock speed of a data bus.

18. The configurable transducer interface of claim 1, wherein:
the hardware connector comprises a pin connector.

19. A configurable transducer interface, comprising:
a communication interface for communicating with an external host; and
a control configured to process data from a transducer, report data from the transducer via the communication interface, and receive transducer-specific configuration data from the external host via the communication interface.

20. The configurable transducer interface of claim 19, further comprising:
a non-volatile memory storing firmware for configuring the control.

21. The configurable transducer interface of claim 20, further comprising:
a circuit board on which the hardware connector, control, communication interface and non-volatile memory are provided.

22. The configurable transducer interface of claim 19, further comprising:
a hardware connector for electrically connecting to the transducer, the hardware connector having a plurality of connection points;
wherein the control is configured with information that identifies pre-assigned functions of the connection points.

23. The configurable transducer interface of claim 22, wherein:
the transducer-specific configuration data identifies a subset of the connections points to be used by the transducer.

24. The configurable transducer interface of claim 22, wherein:
the transducer-specific configuration data identifies respective subsets of the connections points to be used by respective different transducers which are connectable to the hardware connector.

25. Computer readable media having computer readable code embodied thereon for programming at least one processor to perform a method for configuring a transducer interface, the method comprising:
communicating with an external host via a communication interface; and
configuring a control to process data from a transducer, report data from the transducer via the communication interface, and receive transducer-specific configuration data from the external host via the communication interface.

26. The computer readable media of claim 25, wherein:
the transducer-specific configuration data identifies a subset of pin connection points of a pin connector to be used by the transducer; and
the method performed further comprises configuring the control to identify pre-assigned functions of the pin connection points.

27. The computer readable media of claim 26, wherein:
the transducer-specific configuration data identifies respective subsets of the pin connections points to be used by respective different transducers which are connectable to the hardware connector.
